(19) United States
(12) Patent Application Publication
(10) Pub. No.: US 2013/0318932 A1
(43) Pub. Date: Dec. 5, 2013

(54) BAREBACK PAD WITH CUSTOMIZABLE INSERTS

(71) Applicant: Colleen Sweeney Israel, (US)

(72) Inventor: Colleen Sweeney Israel, North Canton, OH (US)

(21) Appl. No.: 13/659,156

(22) Filed: Oct. 24, 2012

Related U.S. Application Data
(60) Provisional application No. 61/655,256, filed on Jun. 4, 2012.

(51) Int. Cl. B68C 1/00

(52) U.S. Cl. CPC B68C 1/00
USPC 54/66

(57) ABSTRACT

A bareback pad with customizable inserts for use in training and/or riding a horse is provided. The bareback pad provides a wide range of flexibility to provide comfort, control and support to both the rider and the horse to improve trust, balance and strength between the two. The invention discloses a modified training pad with removable and pliable inserts at the front and rear of the pad and along the flap.

### FIELD OF THE INVENTION

A bareback pad with customizable inserts for use in training and/or riding a horse is provided. The bareback pad provides a wide range of flexibility to provide comfort, control and support to both the rider and the horse to improve trust, balance and strength between the two. The invention discloses a modified training pad with removable and pliable inserts at the front and rear of the pad and along the flap.

### BACKGROUND OF THE INVENTION

One popular form of horse riding is commonly referred to as bareback riding or essentially the riding of a horse without a traditional saddle. Such riding requires significant skill, balance and coordination as the rider has minimal equipment to compensate for any errors. Some horsemen consider this form of riding natural, for it allows the maximum amount of communication between the rider and the horse. This style of riding also improves the riders balance. The downsides of this style of riding include a higher risk of injury due to possible falls and discomfort for the horse or rider. This discomfort comes from the lack of a saddle. Typically, a rider utilizes a tree type saddle to provide substantial support for both the horse and rider. A saddle also provides padding to the riders seat and the horse's back. Bareback riding is also more taxing to the horse as the rider impacts the horse's spine or if the rider fails to control their body.

In a typical bareback riding situation, the rider slides or shifts more(both front to back and left to right) than they would in a standard saddle. This causes the riders legs to extend forward on the horse more, along the crease between the barrel and the shoulder muscles in order to establish a secure position. This leads to excessive gripping and typically hinders the training of the horse. In order to make proper use of the rider's calf muscles, bareback riders need to keep their heels lower than their toes, riding with a flexed ankle and heel down, as if they had stirrups. Riding with ones toes down can lead to clutching at the horse with the lower legs or digging into the horse's sides with the heels, both often interpreted by the horse as cues adverse to the riders intentions. The classic position of a rider should appear (if one views the rider without the horse underneath) to be in a standing position with knees slightly bent. It is particularly important that riders not squeeze their heels or lower legs into the horse's sides when slowing or stopping or use the reins for a brace as these signals confuse the horse. Again, proper placement of the thigh and upper calf muscle being critical to control of the horse while riding bareback. Correct development of the rider's position, upper body/core, seat, and leg(s) are crucial to advancement in this riding skill set.

The use of a bareback pad can be beneficial for several reasons. The pad allows one to experience close contact between the rider and the horse while developing a secure seat for the rider and providing riding confidence. The use of the pad is mainly to keep the rider clean and to keep the rider and the horse comfortable. Drawbacks with the use of a standard bareback pad involve the rider's legs floating forward and/or discomfort in the riders seat/rear-end. Horse equipment suppliers, such as Christ, have produced saddles with foam type inserts, which attempt to minimize this leg movement and provide comfort. Unfortunately, the pads currently on the market offer no flexibility or adaptability. Christ also offers a wide range of double sheepskin bareback pads, which also lack the adaptability needed.

Attempts to create a bareback pad with inflatable compartments have been made. U.S. Pat. No. 7,137,236 and other commercially available pads disclose this method. Unfortunately, these pads concentrate on cushioning the seat area and offer little in the way of rider and horse interaction let alone securing the riders legs and seat area with any rider options. An inflatable bareback pad only supplies rudimentary cushioning between the horse and rider, and unfortunately, creates additional bulk between the horse and rider. This additional bulk hinders communication from the rider's seat to the horses back muscles. Furthermore, inflatable type saddles/pads are typically thick plastic to retain air, and are not soft/supple to act as a natural cushion, (such as sheepskin). Furthermore, inflatable pads operate primarily in the area underneath the rider, whereas a product is needed which has multiple areas of support and flexible cushioning customizable to the rider's preferences.

It is also a known in the industry that most saddles or bareback pads are not perfect fits for every horse/rider due to the size and shape differences of each individual horse and each individual rider. Rather, each pad/saddle are rough approximations for fit and comfort, and the horse and/or rider suffer due to ill-fitting equipment. Adding to this variation is the complexity of fitting a rider's skill level to the needs of the horse, and the need for a pad with multiple variations becomes readily apparent. Even custom saddles or pads may not properly fit as the horse and or rider may change riding styles or gain or lose weight or strength. It is also desirable to have a transition pad for training an inexperienced rider (such a transition pad would aid in transferring from a standard saddle to a bareback pad). The use of the present invention would assist a rider in properly learning such a transition. Currently there exists a need for a fully adjustable bareback saddle pad which builds a riders confidence to work with their horse.

### SUMMARY OF INVENTION

A bareback pad with customizable inserts for use in training and/or riding a horse is provided. The bareback pad provides a wide range of flexibility to provide comfort, control and support to both the rider and the horse to improve trust, balance and strength between the two. The invention discloses a modified training pad with removable and pliable inserts at the front and rear of the pad.

In one embodiment the invention discloses a customizable bareback pad for training horses comprising a top surface having a substantially contiguous seat portion adjacent to opposing side panels, a pommel area and a cantle area and also having two leg flap areas adjacent to the pommel area and each of the opposing side panels, a bottom surface opposed to the top surface configurable to form a gullet area wherein the horses spine may protrude into the gullet area when the pad is placed on the horse, the pommel area having one or more pommel insert pouches configured to receive one or more inserts with the one or more pommel insert pouches further having one or more fasteners to secure the inserts within the pommel insert pouches, the cantle area having one or more cantle insert pouches configured to receive one or more inserts with the one or more cantle insert pouches further having one or more fasteners to secure the inserts within the cantle insert pouches, the leg flap areas each having one or more leg flap insert pouches configured to receive one or more inserts with the one or more leg flap insert pouches further having one or more fasteners to secure the inserts within the leg flap insert pouches, and one or more inserts for use in the one or more pommel insert pouches cantle insert pouches and/or leg flap insert pouches.

In another embodiment the invention discloses a customizable bareback pad for training horses comprising, a top surface having a substantially contiguous seat portion adjacent to opposing side panels, a pommel area and a cantle area and also having two leg flap areas adjacent to the pommel area and each of the opposing side panels, a bottom surface opposed to the top surface configurable to form a gullet area wherein the horses spine may protrude into the gullet area when the pad is placed on the horse, the pommel area having one or more pommel insert pouches configured to receive one or more inserts with the one or more pommel insert pouches further having one or more fasteners to secure the inserts within the pommel insert pouches, the cantle area having one or more cantle insert pouches configured to receive one or more inserts with the one or more cantle insert pouches further having one or more fasteners to secure the inserts within the cantle insert pouches, the leg flap areas each having one or more leg flap insert pouches configured to receive one or more inserts with the one or more leg flap insert pouches further having one or more fasteners to secure the inserts within the leg flap insert pouches, the side panels each having one or more side panel insert pouches capable to receive one or more inserts with the one or more insert pouches further having one or more fasteners to secure the inserts within the side panel insert pouches, and one or more inserts for use in the one or more pommel insert pouches cantle insert pouches, side panel insert pouches and/or leg flap insert pouches.

In still yet another embodiment the invention discloses a customizable bareback pad for training horses comprising a top surface having a substantially contiguous seat portion adjacent to opposing side panels, a pommel area and a cantle area and also having two leg flap areas adjacent to the pommel area and each of the opposing side panels, a bottom surface opposed to the top surface configurable to form a gullet area wherein the horses spine may protrude into the gullet area when the pad is placed on the horse, the pommel area having one or more pommel insert pouches configured to receive one or more inserts with the one or more pommel insert pouches further having one or more fasteners to secure the inserts within the pommel insert pouches, the leg flap areas each having one or more leg flap insert pouches configured to receive one or more inserts with the one or more leg flap insert pouches further having one or more fasteners to secure the inserts within the leg flap insert pouches, and one or more inserts for use in the one or more pommel insert pouches and/or leg flap insert pouches.

### BRIEF DESCRIPTIONS OF DRAWINGS

FIG. 1 is a side view of the transition pad with the top layer removed to show the inner workings of the inserts with number references.

FIG. 2 is a top view of the transition pad with the top layer removed to show the inner workings of the inserts with number references.

FIG. 3 is a top view of the transition pad with number references.

FIG. 4 is a side view of an alternate embodiment of the transition pad with the top layer removed to show the inner workings of the inserts with number references.

### DETAILED DESCRIPTION

In one embodiment the invention discloses a customizable bareback pad for training horses comprising a top surface having a substantially contiguous seat portion adjacent to opposing side panels, a pommel area and a cantle area and also having two leg flap areas adjacent to the pommel area and each of the opposing side panels, a bottom surface opposed to the top surface configurable to form a gullet area wherein the horses spine may protrude into the gullet area when the pad is placed on the horse, the pommel area having one or more pommel insert pouches configured to receive one or more inserts with the one or more pommel insert pouches further having one or more fasteners to secure the inserts within the pommel insert pouches, the cantle area having one or more cantle insert pouches configured to receive one or more inserts with the one or more cantle insert pouches further having one or more fasteners to secure the inserts within the cantle insert pouches, the leg flap areas each having one or more leg flap insert pouches configured to receive one or more inserts with the one or more leg flap insert pouches further having one or more fasteners to secure the inserts within the leg flap insert pouches, and one or more inserts for use in the one or more pommel insert pouches cantle insert pouches and/or leg flap insert pouches.

In another embodiment the invention discloses a customizable bareback pad for training horses comprising, a top surface having a substantially contiguous seat portion adjacent to opposing side panels, a pommel area and a cantle area and also having two leg flap areas adjacent to the pommel area and each of the opposing side panels, a bottom surface opposed to the top surface configurable to form a gullet area wherein the horses spine may protrude into the gullet area when the pad is placed on the horse, the pommel area having one or more pommel insert pouches configured to receive one or more inserts with the one or more pommel insert pouches further having one or more fasteners to secure the inserts within the pommel insert pouches, the cantle area having one or more cantle insert pouches configured to receive one or more inserts with the one or more cantle insert pouches further having one or more fasteners to secure the inserts within the cantle insert pouches, the leg flap areas each having one or more leg flap insert pouches configured to receive one or more inserts with the one or more leg flap insert pouches further having one or more fasteners to secure the inserts within the leg flap insert pouches, the side panels each having one or more side panel insert pouches capable to receive one or more inserts with the one or more insert pouches further having one or more fasteners to secure the inserts within the side panel insert pouches, and one or more inserts for use in the one or more pommel insert pouches cantle insert pouches, side panel insert pouches and/or leg flap insert pouches.

In still yet another embodiment the invention discloses a customizable bareback pad for training horses comprising a top surface having a substantially contiguous seat portion adjacent to opposing side panels, a pommel area and a cantle area and also having two leg flap areas adjacent to the pommel area and each of the opposing side panels, a bottom surface opposed to the top surface configurable to form a gullet area wherein the horses spine may protrude into the gullet area when the pad is placed on the horse, the pommel area having one or more pommel insert pouches configured to receive one or more inserts with the one or more pommel insert pouches further having one or more fasteners to secure the inserts within the pommel insert pouches, the leg flap areas each having one or more leg flap insert pouches configured to receive one or more inserts with the one or more leg flap insert pouches further having one or more fasteners to secure the inserts within the leg flap insert pouches, and one or more inserts for use in the one or more pommel insert pouches and/or leg flap insert pouches.

The present invention is derived from the traditional classical equine training and is utilized from a colt starting to advanced schooling. Such training concentrates on establishing a strong connection between riders and horse so that they jointly develop trust, balance and strength. The present invention allows great flexibility and can be utilized by all disciplines within the equestrian field. Due to the nature of the pad, it is easily adaptable and can fit nearly any horse and adjust to nearly any rider. Furthermore, the customization of the pad further adapts to a riders style and or need for additional support. Finally, the invention provides a significant amount of comfort for both the horse and rider versus standard bareback pads and items currently known in the industry.

The present invention provides significant advantages over the current state of the art. The present invention has multiple inserts throughout the bareback pad. These inserts vary in number used, height/depth of insert used, and position within the pad. The current state of the art fails to offer customization.

The present invention inserts can be made from a number of materials, with one embodiment including soft and pliable inserts such as, but not limited to gel inserts or memory foam inserts which do not create pressure points on the horse. The current state of the art offers only static padding which fails to provide comfort for the rider and/or horse. The current state of the art may also have design flaws present, which may compromise the safety and comfort of the horse and/or rider and further defeats the purpose of bareback riding/training. The present invention utilizes advanced materials in its design to create a superior final product. The current marketplace offers significantly lower quality designs and materials that cause pressure points, rubbing and slipping. Finally, the present invention is versatile for all disciplines of riding and offers a classic horsemanship appearance while the current state of the art only has type specific functionality and appearance.

### Example of Use

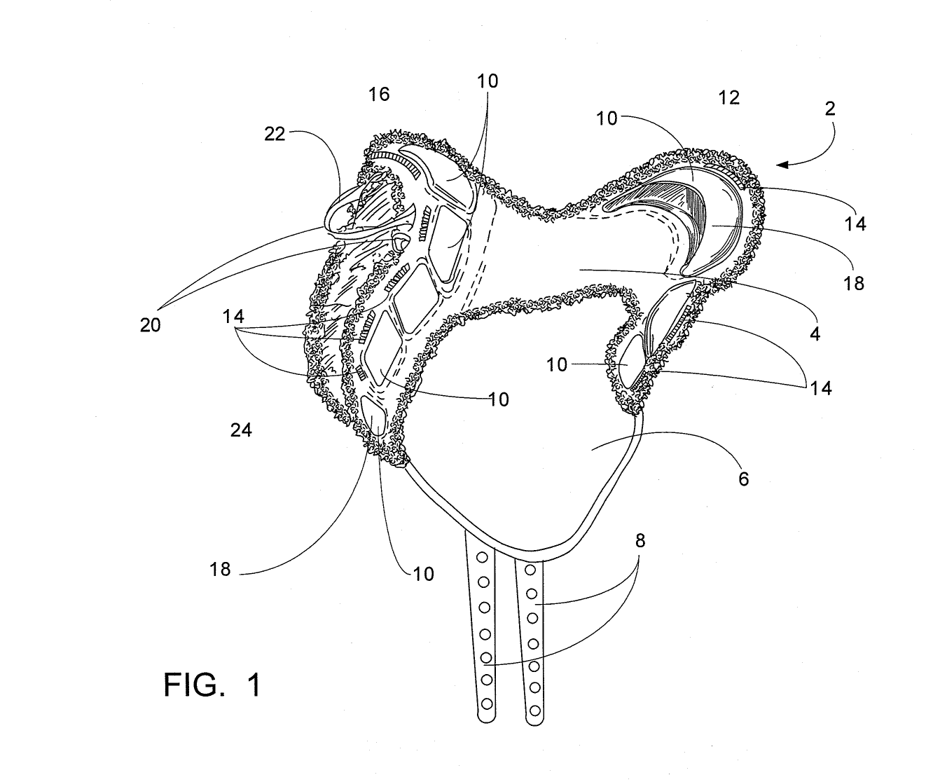

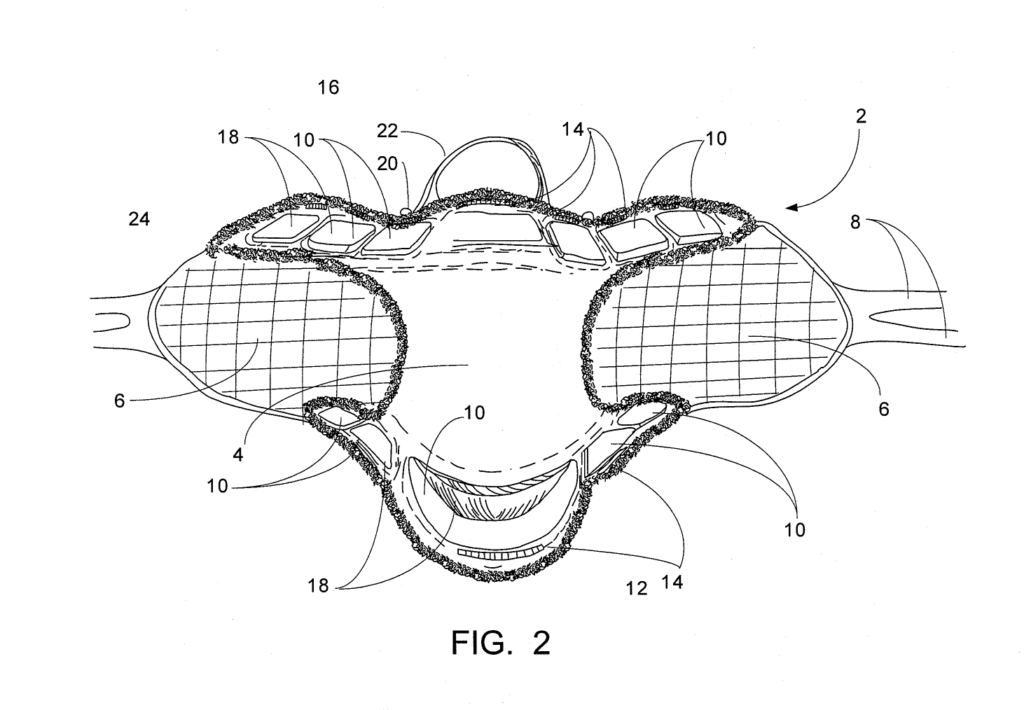

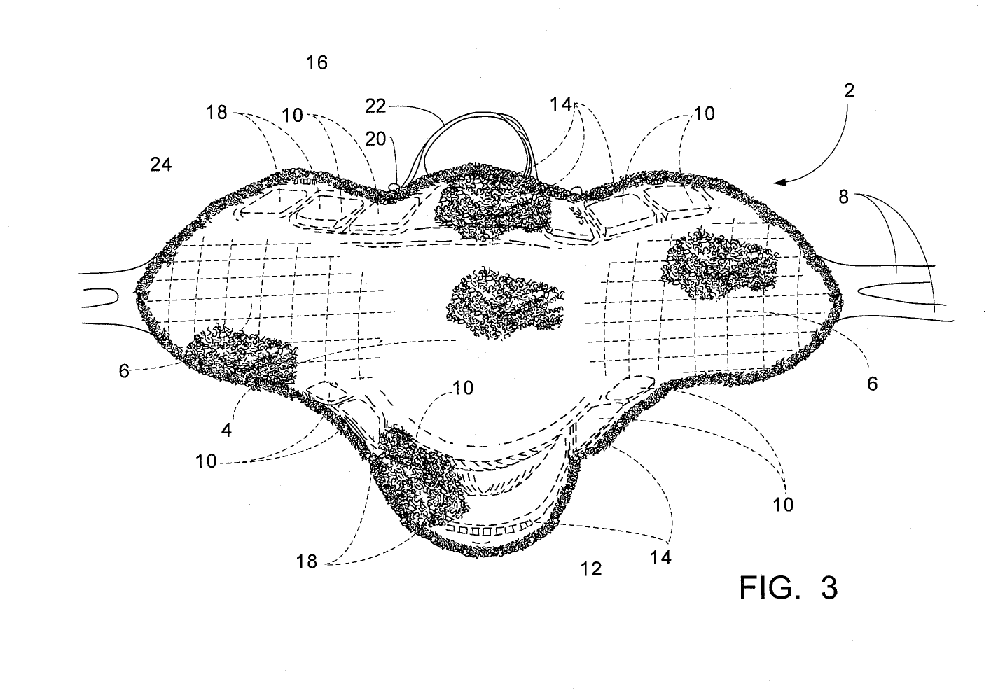

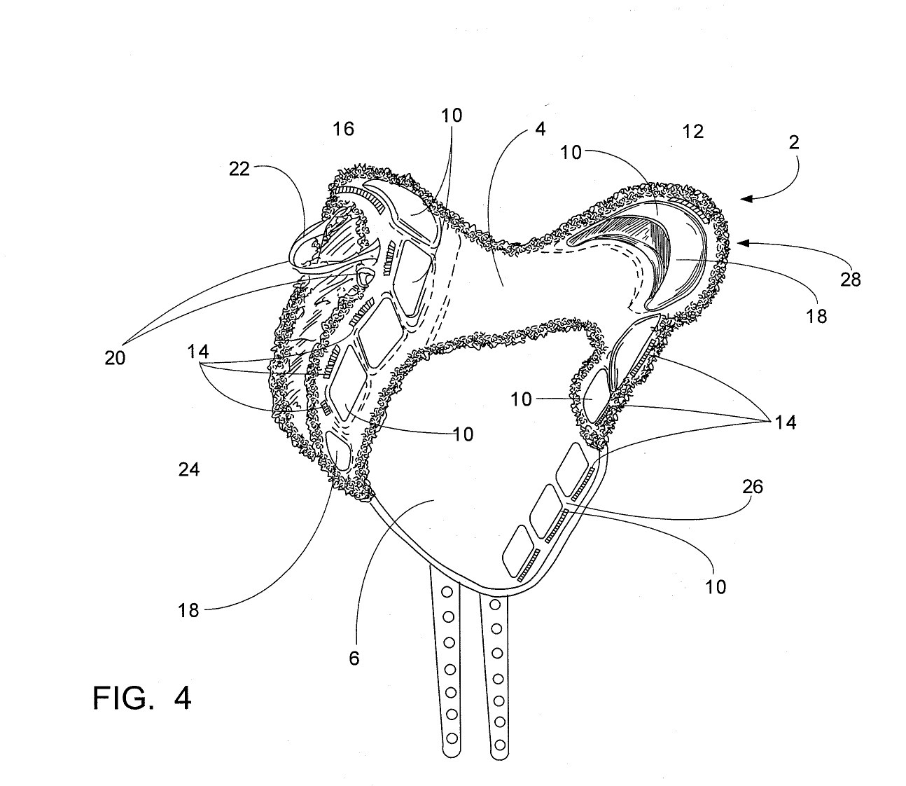

FIG. 1 details transition bareback pad 2 from a side view, with the top layer removed to show the inner workings of the inserts, as it would sit upon a horse. FIG. 2 details the same bareback pad 2 from a top view with the top layer removed to show the inner workings of the inserts, or what a rider would see if sitting atop a horse. FIG. 3 details the same bareback pad 2 from a top view with the top layer intact (or as the invention typically operates). FIG. 4 details an alternate embodiment which includes inserts along the back of a riders leg(s). The following descriptions are exemplarily and are not limited to the following embodiments.

The bareback pad of the following invention is similar to standard bareback pads in the orientation and use upon a horse but having significant differences in its modification for riding/training a horse. The area commonly referred to as seat 4 can, in one embodiment, be one, two, or more layers of a medical grade sheepskin with the fleece out for both horse and rider comfort. Seat 4 conforming to the horse back and having a slip-resistant underside so as to hold its place on the horse's back. Typically, the slip resistance accomplished with the fleece being out and located next to the horse back. Seat 4 being made in one embodiment from medical grade sheepskin to allow for natural breathability and having the ability to disperse pressure and heat better. The sheepskin used to conform to the horse and rider. Optionally, the material for the seat, knee roll area, thigh block area and contact area for the horse is made from, but not limited to, double fleece, cotton, wool, split hide suede, nylon, cow skin, pig skin, sheep skin, non-medical grade sheepskin or some combination thereof. In yet another option, the invention may be constructed entirely of man-made materials in place of the natural textiles or animal hides. In still yet another embodiment, the invention may be constructed from a combination of natural and man-made materials. In one configuration, a double layer medical grade sheepskin configured with the fleece out and hide sides facing one another being preferred as the fleece contacts both the horse and rider.

The leg flap area 24, which can be part of the flaps 6 (or alternatively side panels) or immediately adjacent to flaps 6, can be made of several materials, including, but not limited to, cotton, cloth, wool, felt or split hide suede. Flaps 6, preferably constructed from, but not limited to, durable and supple materials, both man-made and/or natural. In the alternative, flap 6 can be made from synthetic materials. Other options for flaps 6 include double fleece, cotton, wool, split hide suede, nylon, cow skin, pig skin, sheep skin, non-medical grade sheepskin or some combination thereof. To keep the pad secured to the horse are one or more billets 8 which in one embodiment can be made with a western cinch. In one embodiment, English style billets are made of, but not limited to, leather or synthetic material, or in the alternative the pad is fitted with a western cinch, which can be made from leather with padding. In one embodiment, seat 4 and flaps 6 are arranged to create gullet area 28. This area typically being formed so that the horses spine may protrude into gullet area 28 when pad 2 is placed on the horse.

To help secure a rider's seat or rear end, are one or more insert pouches 10 which are located in the area commonly referred to as the cantle area 12. Typically insert pouches 10 in cantle area 12 will range down through the thigh block area and a seat bone elevator. Pouches 10 in the cantle area, helping pad 2 mimic a traditional saddle. One or more insert pouches 10 are also located in the front or pommel area 16. One or more insert pouches 10 are also located in the leg flap area 24. The number of insert pouches 10 located in the pommel, cantle and leg flap areas can vary depending on the application. In one embodiment, pouches in pommel area 16 and leg flap area 24 range from the pommel down to the knee roll area. Pouches 10 in the pommel area typically keeping a riders legs stable. In another embodiment, pouches in cantle area 12 and leg flap area 24 located from the top of the seat/cantle area down to the end of flap 6. FIG. 4 provides yet another embodiment, where insert pouches 10 in the flap (or side panel) area 6, are located so as to secure the back (or dorsal/medial) side of a riders leg. This option allows for inserts to be located at or near the back of the riders leg(s). In this embodiment, insert pouches 10 being located at or near the edge 26 at the cantle or rear of pad 2, but still located on and/or near side panel 6.

In one embodiment, from 1 to 15 insert pouches 10 are located in the cantle area 12. In another embodiment from 1 to 21 insert pouches 10 are located in the pommel area 16. In another embodiment from 1 to 24 insert pouches 10 are located in the leg flap area 24. In still yet another embodiment from 1 to 15 insert pouches 10 are located in the cantle area, from 1 to 21 insert pouches 10 are located in the pommel area and 1 to 12 insert pouches 10 are located in the leg flap area. In another embodiment from 1 to 24 insert pouches 10 are located in the flap (or side panel) area 6. In still yet another embodiment, from 3 to 9 insert pouches 10 are located in the cantle area, from 6 to 13 insert pouches 10 are located in the pommel area, and from 4 to 8 insert pouches 10 are located in the leg flap area. In another embodiment, from 3 to 9 insert pouches 10 are located in the cantle area, from 6 to 13 insert pouches 10 are located in the pommel area, from 4 to 8 insert pouches 10 are located in the leg flap area, and from 2 to 8 insert pouches 10 are located in the flap (or side panel) area. In still yet another embodiment, insert pouches 10 being equally distributed on the left and right sides of bareback pad 2. In another embodiment, insert pouches 10 being distributed unevenly on the left versus right side of bareback pad 2, and in some embodiments being only on one side of bareback pad 2. The setup and arrangement of insert pouches varying depending on the style of rider, size of horse and type of riding/training desired.

Insert pouches 10 being located in the pommel area 16 and leg flap area 24 to prevent a riders legs from rising up or moving around excessively on the horse. Insert pouches 10 being located in the cantle area 12 to secure a riders seat or rear end and provide some level of comfort during the ride. As a means of optimizing communication between horse and rider, a rider cultivates an independent seat, a long/strong leg with control over excess movement, and a strong upper body/core. The present invention provides the ideal support for each stage of a rider's advancement, and facilitates the desired improvements for horse and rider. As a rider further connects with the horse and improves their body control, the horse feels more confident and the communications become considerably clearer between horse and rider. The customization options available with the present invention allow the rider to adjust with each ride. Insert pouches 10 allow a range from full support to no support with various inserts. In one embodiment, inserts only contacting the rider. Thus, a rider can assess their needs with each ride and add or subtract an insert 18 as needed. A rider can also remove insert 18 in a specific area as confidence grows, but retain insert 18 in another area where additional confidence is desired. A rider may also change from a thicker to a thinner insert 18 and vice versa. Such options permit the rider to explore their limits and abilities in comfort. This versatility allows for rider progress and avoids having a rider become tense or tight while they become better balanced and stronger. The adaptability of the present invention is also highly beneficial for the horse, as horses comply to training when confidence and leadership is demonstrated by the rider. It is known in the art that a willing horse is safer to ride and thus becomes a better athlete. Hence, the present invention fosters an improved partnership between horse and rider.

Another embodiment involves the use of pad 2 for non-traditional or handicapped riders. Such riders would include, but are not limited to, those with handicaps, missing or abnormal appendages, differing postures, or a need for support in an area not normal to the traditional riding stance/posture. In such an embodiment, pad 2 can be customized to accept one or more inserts 18 and insert pouches 10 nearly anywhere in the pad. Such customization would involve a change to the basic pad setup to provide support in where necessary. Typically these additional inserts 18 and insert pouches 10 located in the seat 4 or side panel 6 areas.

In one embodiment, insert pouches 10 being concealed so they cannot be readily seen from the top of pad 2. In another embodiment, insert pouches 10 being partially concealed so they can only be slightly discernible from top of pad 2. In another embodiment, insert pouches 10 being located so that they do not distress the horse or place the horse in any discomfort. In still yet another embodiment insert pouches 10 being placed into one or more rows. In yet another embodiment, insert pouches 10 having access (to the pouch) from the from the top, bottom, or either side.

Into each of these insert pouches 10 are located one or more inserts 18. The inserts being made from, but not limited to, a gel, Lanolin, foam, gel foam, polyethylene, polyurethane, soy-based polymer, rubber, Visco, Visco-latex, synthetic latex, a natural latex based material, a synthetic polymer or a naturally occurring polymer. In the alternative insert(s) 18 can be from a variety of materials which provide soft and pliable material for interaction with the horse and to secure a rider to the level they desire. Such alternative materials include, but are not limited to, foam, memory foam, hi density foam or other synthetic materials. Inserts are made from soft (or semi-soft) and pliable material to maximize the comfort for the horse and provide complete interaction between the horse and rider. Insert(s) 18 typically consisting of a firm but pliable substance to support the rider without creating a pressure point on the horse or alternatively the rider. In one embodiment, the density of the inserts being, but not limited to, between 0.85 and 1.1 g/cm³.

The insert 18 typically residing one per insert pouch 10, but in the alternative can be two or more inserts per pouch 10 if additional depth or mass is required. Insert 18 providing a ridge, bump, stop, mound, or the like to prevent the movement of ones legs or rear end and to help further secure the rider in the saddle. In one embodiment, the one or more inserts 18 not being visible or acting as a sculpted potion of the pad. In another embodiment, the size of the insert varying depending on the support desired, For example, the insert being thicker when more support is needed and thinner as a rider requires less support. In yet another embodiment the inserts being tapered. In yet another embodiment the inserts being rounded. In still yet another embodiment, the size and shape of the insert being variable.

Insert 18 typically supporting the seat, leg or pelvis, with the insert being varied depending on the needs of the rider. Inserts 18 are removable as the rider decides on placement location. The rider may also choose to use no insert(s), insert(s) in just the pommel area or insert(s) in just the cantle area. The rider may also opt for inserts 18 only on the left (or right) side of the horse. The use of inserts 18 and positions thereof being completely flexible, optional or adaptable. Alternatively the rider may permanently attach one or more inserts into one or more locations on the pad.

The shape of the insert(s) 18 may vary and include, but are not limited to oval, rectangular, rhomboid, elliptical, triangular, round, square, crescent, egg, pentagon, hexagon, octagon or diamond shaped insert(s) 18. In one embodiment, inserts 18 provide support for the rider and create a supple barrier to assist the rider in making corrections to their position. When the rider's position drifts and contacts insert 18, it becomes a subtle reminder to the rider to adjust their position on the horse. Insert 18 assisting the rider by stopping the “drift” of a respective body part with the rider becoming aware of the error and adjusting. In one embodiment, insert 18 being supple so that it does not create a rigid wall or block. In this scenario, insert 18 requires the rider rectify their errors rather that use the barrier as a crutch. Saddles are often fitted with rigid blocks and riders habitually use the blocks to compensate for their own weaknesses. In one embodiment, inserts 18 being contained inside the double sheepskin, and accessible to the rider via small opening on the top surface of the pad. In another embodiment, inserts 18 being contained inside the double sheepskin, and accessible to the rider via complete or partial removal of the top surface (in such a scenario a securing means for the top surface being employed to secure to the bottom surface).

Securing the one or more insert(s) 18 in its respective insert pouch 10 there are one or more fasteners 14. In one embodiment, fastener 14 being made from Velcro, but alternatively can be any material or means which secures insert 18 into pouch 10. In another embodiment, fastener(s) 14 including, but not limited to Velcro, button, snap, tie-offs, magnetic, or envelope style closure. In one embodiment, fastener 14 is located so as to not bother the horse or present any discomfort to the horse. For example, the use of Velcro as a fastener 14 must be so located that the animal does not feel fastener 14 in a manner which would introduce discomfort. Typically, at least one fastener 14 is needed for each pouch 10. In another embodiment, fastener 14 concealed inside the material used to make seat 4. In still yet another embodiment one or more of inserts 10 are sewn into or permanently affixed on/in pad 2.

Alternatively, pad 2 includes the use of an optional ring 20 for attachments. Ring 20 can be a ring, gullet, grommet or anything that allows the rider to attach additional materials to the pad 2. In another optional arrangement, a handle 22 is included. Handle 22 used as an emergency area for the rider to grab to stabilize oneself.

Other materials that can be used include cotton, wool, split hide sued and leather for the flaps and leather for the billet. The girthing can be any number of designs, but is preferably English or western in nature.

1. A customizable bareback pad for training horses comprising:
a) a top surface having a substantially contiguous seat portion adjacent to opposing side panels, a pommel area and a cantle area and also having two leg flap areas adjacent to the pommel area and each of the opposing side panels;
b) a bottom surface opposed to the top surface configurable to form a gullet area wherein the horses spine may protrude into the gullet area when the pad is placed on the horse;
c) the pommel area having one or more pommel insert pouches configured to receive one or more inserts with the one or more pommel insert pouches further having one or more fasteners to secure the inserts within the pommel insert pouches;
d) the cantle area having one or more cantle insert pouches configured to receive one or more inserts with the one or more cantle insert pouches further having one or more fasteners to secure the inserts within the cantle insert pouches;
e) the leg flap areas each having one or more leg flap insert pouches configured to receive one or more inserts with the one or more leg flap insert pouches further having one or more fasteners to secure the inserts within the leg flap insert pouches; and
f) one or more inserts for use in the one or more pommel insert pouches, cantle insert pouches, and/or leg flap insert pouches.

2. The customizable bareback pad of claim 1 wherein one or more insert pouches located in the seat and/or the side panels are configured to receive one or more inserts.

3. The customizable bareback pad of claim 1 wherein there are from 1 to 21 pommel insert pouches.

4. The customizable bareback pad of claim 1 wherein there are from 1 to 15 cantle insert pouches.

5. The customizable bareback pad of claim 1 wherein there are from 1 to 24 leg flap insert pouches.

6. The customizable bareback pad of claim 1 wherein the top surface and bottom surface are double fleece, cotton, wool, split hide suede, nylon, cow skin, pig skin, sheep skin, non-medical grade sheepskin or a combination thereof.

7. The customizable bareback pad of claim 1 wherein the one or more inserts are gel, Lanolin, foam, gel foam, polyethylene, polyurethane, soy-based polymer, rubber, Visco, Visco-latex, synthetic latex, a natural latex based material, a synthetic polymer or a natural polymer.

8. The customizable bareback pad of claim 1 wherein the one or more fasteners are Velcro closures, buttons, snaps, tie-offs, magnetic closures or envelope style closures.

9. A customizable bareback pad for training horses comprising:
a) a top surface having a substantially contiguous seat portion adjacent to opposing side panels, a pommel area and a cantle area and also having two leg flap areas adjacent to the pommel area and each of the opposing side panels;
b) a bottom surface opposed to the top surface configurable to form a gullet area wherein the horses spine may protrude into the gullet area when the pad is placed on the horse;
c) the pommel area having one or more pommel insert pouches configured to receive one or more inserts with the one or more pommel insert pouches further having one or more fasteners to secure the inserts within the pommel insert pouches;
d) the cantle area having one or more cantle insert pouches configured to receive one or more inserts with the one or more cantle insert pouches further having one or more fasteners to secure the inserts within the cantle insert pouches;
e) the leg flap areas each having one or more leg flap insert pouches configured to receive one or more inserts with the one or more leg flap insert pouches further having one or more fasteners to secure the inserts within the leg flap insert pouches;
f) the side panels each having one or more side panel insert pouches capable to receive one or more inserts with the one or more insert pouches further having one or more fasteners to secure the inserts within the side panel insert pouches; and
g) one or more inserts for use in the one or more pommel insert pouches cantle insert pouches, side panel insert pouches and/or leg flap insert pouches.

10. The customizable bareback pad of claim 9 wherein one or more insert pouches located in the seat and/or the side panels are configured to receive one or more inserts.

11. The customizable bareback pad of claim 9 wherein there are from 1 to 21 pommel insert pouches.

12. The customizable bareback pad of claim 9 wherein there are from 1 to 15 cantle insert pouches.

13. The customizable bareback pad of claim 9 wherein there are from 1 to 24 leg flap insert pouches.

14. The customizable bareback pad of claim 9 wherein there are from 1 to 24 side flap insert pouches.

15. The customizable bareback pad of claim 9 wherein the top surface and bottom surface are double fleece, cotton, wool, split hide suede, nylon, cow skin, pig skin, sheep skin, non-medical grade sheepskin or a combination thereof.

16. The customizable bareback pad of claim 9 wherein the one or more inserts are gel, Lanolin, foam, gel foam, polyethylene, polyurethane, soy-based polymer, rubber, Visco, Visco-latex, synthetic latex, a natural latex based material, a synthetic polymer or a natural polymer.

17. The customizable bareback pad of claim 9 wherein the one or more fasteners are Velcro closures, buttons, snaps, tie-offs, magnetic closures or envelope style closures.

18. A customizable bareback pad for training horses comprising:
a) a top surface having a substantially contiguous seat portion adjacent to opposing side panels, a pommel area and a cantle area and also having two leg flap areas adjacent to the pommel area and each of the opposing side panels;
b) a bottom surface opposed to the top surface configurable to form a gullet area wherein the horses spine may protrude into the gullet area when the pad is placed on the horse;
c) the pommel area having one or more pommel insert pouches configured to receive one or more inserts with the one or more pommel insert pouches further having one or more fasteners to secure the inserts within the pommel insert pouches;
d) the leg flap areas each having one or more leg flap insert pouches configured to receive one or more inserts with the one or more leg flap insert pouches further having one or more fasteners to secure the inserts within the leg flap insert pouches; and
e) one or more inserts for use in the one or more pommel insert pouches and/or leg flap insert pouches.

19. The customizable bareback pad of claim 18 wherein there are from 1 to 21 pommel insert pouches.

20. The customizable bareback pad of claim 18 wherein there are from 1 to 24 leg flap insert pouches.

21. The customizable bareback pad of claim 18 wherein:
a) the top surface and bottom surface are double fleece, cotton, wool, split hide suede, nylon, cow skin, pig skin, sheep skin, non-medical grade sheepskin or a combination thereof;
b) the one or more inserts are gel, Lanolin, foam, gel foam, polyethylene, polyurethane, soy-based polymer, rubber, Visco, Visco-latex, synthetic latex, a natural latex based material, a synthetic polymer or a natural polymer; and
c) the one or more fasteners are Velcro closures, buttons, snaps, tie-offs, magnetic closures or envelope style closures.
